(19) United States
(12) Patent Application Publication
(10) Pub. No.: US 2024/0080721 A1
(43) Pub. Date: Mar. 7, 2024

(54) INFORMATION PROCESSING METHOD AND APPARATUS, TERMINAL, AND NETWORK SIDE DEVICE

(71) Applicant: VIVO MOBILE COMMUNICATION CO., LTD., Dongguan (CN)

(72) Inventor: Peng SUN, Dongguan (CN)

(73) Assignee: VIVO MOBILE COMMUNICATION CO., LTD., Dongguan (CN)

(21) Appl. No.: 18/507,053

(22) Filed: Nov. 12, 2023

Related U.S. Application Data
(63) Continuation of application No. PCT/CN2022/092203, filed on May 11, 2022.

(30) Foreign Application Priority Data
May 12, 2021 (CN) 202110518391.6

(51) Int. Cl. H04W 36/00; H04W 36/36

(52) U.S. Cl. CPC H04W 36/0055; H04W 36/36

(57) ABSTRACT

A method for information processing is disclosed. The method includes: receiving, by a terminal, first information sent by a first device entity; and performing, by the terminal, a first operation according to the first information, where the first information includes at least one of the following: a service feature extraction request used to indicate the terminal to perform the first operation based on a first processing method; first sub-information used to indicate the first processing method; first assistance information used for the first processing method; result information obtained by performing processing based on a second processing method; an indication used to request second sub-information, where the second sub-information includes terminal-related information or information obtained by performing information feature hiding on the terminal-related information; and an indication used to request third sub-information, where the third sub-information is used to update a third processing method.

### CROSS-REFERENCE TO RELATED APPLICATIONS

This application is a continuation of International Application No. PCT/CN2022/092203, filed May 11, 2022, which claims priority to Chinese Patent Application No. 202110518391.6, filed May 12, 2021. The entire contents of each of the above-referenced applications are expressly incorporated herein by reference.

### TECHNICAL FIELD

This application relates to the field of communication technologies, and in particular, relates to an information processing method and apparatus, a terminal, and a network side device.

### BACKGROUND

In a communication system, a network side device generally determines a communication state of a terminal. For example, the network side device generally implements a handover policy and/or decision, and the like according to only related information of a base station, resulting in poor communication reliability of the terminal.

### SUMMARY

Embodiments of this application provide an information processing method and apparatus, a terminal, and a network side device.

According to a first aspect, an information processing method is provided, including:
receiving, by a terminal, first information sent by a first device entity; and
performing, by the terminal, a first operation according to the first information, where
the first information includes at least one of the following:
a service feature extraction request, where the service feature extraction request is used to indicate the terminal to perform the first operation based on a first processing method;
first sub-information used to indicate the first processing method;
first assistance information used for the first processing method;
result information obtained by performing processing based on a second processing method;
an indication used to request second sub-information, where the second sub-information includes terminal-related information or information obtained by performing information feature hiding on the terminal-related information; or
an indication used to request third sub-information, where the third sub-information is used to update a third processing method.

According to a second aspect, an information processing method is provided, including:
sending, by a first device entity, first information to a terminal, where
the first information is used to trigger the terminal to perform a first operation, and the first information includes at least one of the following:
a service feature extraction request, where the service feature extraction request is used to indicate the terminal to perform the first operation based on a first processing method;
first sub-information used to indicate the first processing method;
first assistance information used for the first processing method;
result information obtained by performing processing based on a second processing method;
an indication used to request second sub-information, where the second sub-information includes terminal-related information or information obtained by performing, information feature hiding on the terminal-related information; or
an indication used to request third sub-information, where the third sub-information is used to update a third processing method.

According to a third aspect, an information processing method is provided, including:
sending, by a second device entity, first target information to a first device entity, where the first target information includes related information of the second device entity or information obtained by performing second preset processing on the related information of the second device entity, and the first target information is used to determine first information sent by the first device entity to a terminal, where
the first information is used to trigger the terminal to perform a first operation, and the first information includes at least one of the following:
first sub-information used to indicate the first processing method;
first assistance information used for the first processing method; or
result information obtained by performing processing based on a second processing method.

According to a fourth aspect, an information processing apparatus is provided, including:
a first receiving module, configured to receive first information sent by a first device entity; and
an execution module, configured to perform a first operation according to the first information, where
the first information includes at least one of the following:
a service feature extraction request, where the service feature extraction request is used to indicate the terminal to perform the first operation based on a first processing method;
first sub-information used to indicate the first processing method;
first assistance information used for the first processing method;
result information obtained by performing processing based on a second processing method;
an indication used to request second sub-information, where the second sub-information includes terminal-related information or information obtained by performing information feature hiding on the terminal-related information; or
an indication used to request third sub-information, where the third sub-information is used to update a third processing method.

According to a fifth aspect, an information processing apparatus is provided, including:
a second sending module, configured to send first information to a terminal, where
the first information is used to trigger the terminal to perform a first operation, and the first information includes at least one of the following:
a service feature extraction request, where the service feature extraction request is used to indicate the terminal to perform the first operation based on a first processing method;
first sub-information used to indicate the first processing method;
first assistance information used for the first processing method;
result information obtained by performing processing based on a second processing method;
an indication used to request second sub-information, where the second sub-information includes terminal-related information or information obtained by performing information feature hiding on the terminal-related information; or
an indication used to request third sub-information, where the third sub-information is used to update a third processing method.

According to a sixth aspect, an information processing apparatus is provided, including:
a third sending module, configured to send first target information to a first device entity, where the first target information includes related information of the second device entity or information obtained by performing second preset processing on the related information of the second device entity, and the first target information is used to determine first information sent by the first device entity to a terminal, where
the first information is used to trigger the terminal to perform a first operation, and the first information includes at least one of the following:
first sub-information used to indicate the first processing method;
first assistance information used for the first processing method; or
result information obtained by performing processing based on a second processing method.

According to a seventh aspect, a terminal is provided. The terminal includes a processor, a memory, and a program or an instruction that is stored in the memory and that can be run on the processor, where the program or the instruction is executed by the processor to implement the steps of the method in the first aspect.

According to an eighth aspect, a terminal is provided, including a processor and a communication interface, where
the communication interface is configured to receive first information sent by a first device entity; and
the processor is configured to perform a first operation according to the first information, where
the first information includes at least one of the following:
a service feature extraction request, where the service feature extraction request is used to indicate the terminal to perform the first operation based on a first processing method;
first sub-information used to indicate the first processing method;
first assistance information used for the first processing method;
result information obtained by performing processing based on a second processing method;
an indication used to request second sub-information, where the second sub-information includes terminal-related information or information obtained by performing information feature hiding on the terminal-related information; or
an indication used to request third sub-information, where the third sub-information is used to update a third processing method.

According to a ninth aspect, a network side device is provided. The network side device includes a processor, a memory, and a program or an instruction that is stored in the memory and that can be run on the processor, where the program or the instruction is executed by the processor to implement the steps of the method in the second aspect or the steps of the method in the third aspect.

According to a tenth aspect, a network side device is provided, including a processor and a communication interface, where
the communication interface is configured to send first information to a terminal, where
the first information is used to trigger the terminal to perform a first operation, and the first information includes at least one of the following:
a service feature extraction request, where the service feature extraction request is used to indicate the terminal to perform the first operation based on a first processing method;
first sub-information used to indicate the first processing method;
first assistance information used for the first processing method;
result information obtained by performing processing based on a second processing method;
an indication used to request second sub-information, where the second sub-information includes terminal-related information or information obtained by performing information feature hiding on the terminal-related information; or
an indication used to request third sub-information, where the third sub-information is used to update a third processing method.

In some embodiments, the communication interface is configured to send first target information to a first device entity, where the first target information includes related information of the second device entity or information obtained by performing second preset processing on the related information of the second device entity, and the first target information is used to determine first information sent by the first device entity to a terminal, where
the first information is used to trigger the terminal to perform a first operation, and the first information includes at least one of the following:
first sub-information used to indicate the first processing method;
first assistance information used for the first processing method; or
result information obtained by performing processing based on a second processing method.

According to an eleventh aspect, a readable storage medium is provided. The readable storage medium stores a program or an instruction, and the program or the instruction is executed by a processor to implement the steps of the method in the first aspect, or the steps of the method in the second aspect, or the steps of the method in the third aspect.

According to a twelfth aspect, an embodiment of this application provides a chip. The chip includes a processor and a communication interface, the communication interface is coupled to the processor, and the processor is configured to run a program or an instruction to implement the steps of the method in the first aspect, or the steps of the method in the second aspect, or the steps of the method in the third aspect.

According to a thirteenth aspect, a computer program/program product is provided. The computer program/program product is stored in a storage medium, and the computer program/program product is executed by at least one processor to implement the method in the first aspect, or the method in the second aspect, or the steps of the method in the third aspect.

In the embodiments of this application, a terminal receives first information sent by a first device entity; and the terminal performs a first operation according to the first information, where the first information includes at least one of the following: a service feature extraction request, where the service feature extraction request is used to indicate the terminal to perform the first operation based on a first processing method; first sub-information used to indicate the first processing method; first assistance information used for the first processing method; result information obtained by performing processing based on a second processing method; an indication used to request second sub-information, where the second sub-information includes terminal-related information or information obtained by performing information feature hiding on the terminal-related information, or an indication used to request third sub-information, where the third sub-information is used to update a third processing method. Because the terminal performs the first operation according to the first information, a handover policy and/or decision may be implemented by using the terminal-related information. In the embodiments of this application, communication reliability of the terminal is improved.

### BRIEF DESCRIPTION OF DRAWINGS

FIG. 1 is a structural diagram of a network system to which the embodiments of this application can be applied;

FIG. 2 is a first flowchart of an information processing method according to an embodiment of this application;

FIG. 3 is a second flowchart of an information processing method according to an embodiment of this application;

FIG. 4 is a third flowchart of an information processing method according to an embodiment of this application;

FIG. 5 is a first structural diagram of an information processing apparatus according to an embodiment of this application;

FIG. 6 is a second structural diagram of an information processing apparatus according to an embodiment of this application;

FIG. 7 is a third structural diagram of an information processing apparatus according to an embodiment of this application;

FIG. 8 is a structural diagram of a communication device according to an embodiment of this application;

FIG. 9 is a structural diagram of a terminal according to an embodiment of this application; and

FIG. 10 is a structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

In the specification and claims of this application, the terms “first”, “second”, and the like are intended to distinguish between similar objects but do not describe a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims. “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. The following descriptions describe a New Radio (NR) system for example purposes, and NR terms are used in most of the following descriptions, but these technologies can also be applied to an application other than an NR system application, for example, a 6^{th} generation (6G) communication system.

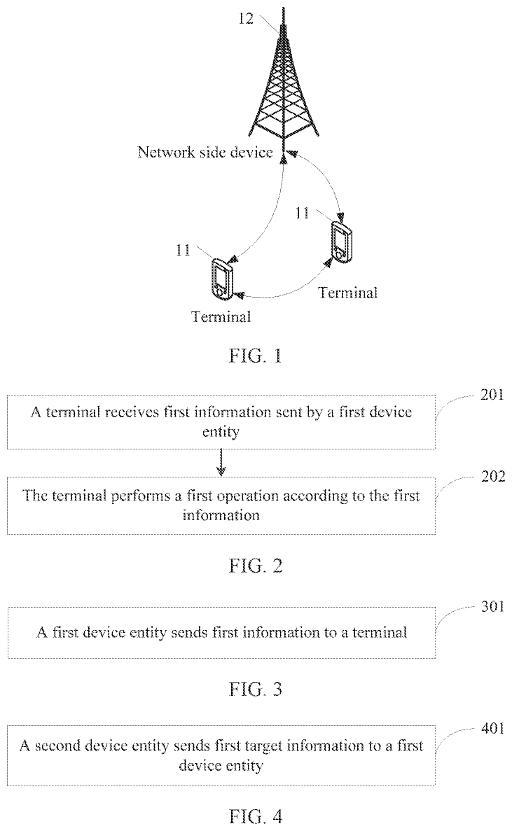

FIG. 1 is a block diagram of a wireless communication system to which embodiments of this application can be applied. The wireless communication system includes a terminal 11 and a network side device 12. The terminal 11 may also be referred to as a terminal device or User Equipment (UE). The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), a wearable device, vehicle user equipment (VUE), or pedestrian user equipment (PUE). The wearable device includes a smart watch, a bracelet, a headset, glasses, and the like. It should be noted that a specific type of the terminal 11 is not limited in the embodiments of this application. The network side device 12 may be a base station or a core network device. The base station may be referred to as a NodeB, an evolved NodeB, an access point, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a WLAN access point, a Wi-Fi node, a Transmitting Receiving Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

With reference to the accompanying drawings, an information processing method provided in the embodiments of this application is described in detail by using some embodiments and application scenarios thereof

Referring to FIG. 2, FIG. 2 is a flowchart of an information processing method according to an embodiment of this application. As shown in FIG. 2, the method includes the following steps:
Step 201: A terminal receives first information sent by a first device entity.
Step 202: The terminal performs a first operation according to the first information.

The first information includes at least one of the following:
a service feature extraction request, where the service feature extraction request is used to indicate the terminal to perform the first operation based on a first processing method;
first sub-information used to indicate the first processing method;
first assistance information used for the first processing method;
result information obtained by performing processing based on a second processing method;
an indication used to request second sub-information, where the second sub-information includes terminal-related information or information obtained by performing information feature hiding on the terminal-related information; or
an indication used to request third sub-information, where the third sub-information is used to update a third processing method.

Operation behavior of the first operation may be set according to an actual requirement. For example, in some embodiments, the first operation may include but is not limited to the following operation behavior: a service feature extraction-related operation, a beam measurement-related operation, beam or channel measurement reporting, a beam or channel prediction-related operation, and a positioning-related operation.

It should be understood that the first information may include one or more of the first sub-information, the first assistance information, the result information, the indication used to request the second sub-information, and the indication used to request the third sub-information. When the first information includes a plurality of pieces of information, the plurality of pieces of information may be transmitted by using one or more pieces of signaling.

In this embodiment of this application, the first processing method may include a method for processing by using a first neural network, and the first sub-information includes neural network-related information of the first neural network. Specifically, the terminal-related information may be inferred by using the first processing method to implement the first operation. Because the terminal performs the first operation by using the first processing method, the first operation may be performed by using the terminal-related information. The neural network-related information may include at least one of a structure of the neural network or a parameter of the neural network. Reporting is performed based on an execution result of the first operation, so that accuracy of implementing a handover policy and/or decision can be improved, and communication reliability of the terminal can be improved. It should be noted that in this embodiment of this application, the first information may directly carry content of the first assistance information, or may implicitly indicate the first assistance information by using a network parameter of the first neural network. For example, in a case that the first sub-information of the first processing method includes neural network-related information of a first neural network and the first assistance information is obtained after first preset processing is performed on the first target information, the first assistance information is implied in a network parameter of the first neural network.

In some embodiments, the first entity device and the second entity device may he understood as entity devices on a network side, or may be network side devices. Specifically, the first entity device and the second entity device may be a same entity device, or may be different entity devices. In some embodiments, the first device entity is one or more network elements that collect and distribute information. For example, the first device entity includes one or at least two of the following: a base station, a Location Management Function (LMF), a Network Data Analytics Function (NWDAF), a first network element, and a second network element, where the first network element is a network element configured to perform the second processing method, and the second network element is configured to perform at least one of the following: performing information collection on information required by the second processing method, or performing information calculation on the information required by the second processing method. The second device entity is configured to provide a network service for the terminal, and the second device entity is a base station, a core network device, or another network element other than the base station and the core network device.

It should be understood that the first processing method may be stipulated in advance in a protocol, or may be indicated by the first device entity by using the first sub-information. When the first information includes the first assistance information used for the first processing method, the terminal-related information and the related information of the second entity device may be inferred based on the first processing method indicated by the first sub-information or the first processing method stipulated in the protocol.

The second processing method may be understood as a method in which the second device entity is configured to infer the terminal-related information or the terminal-related information and the related information of the second entity device. The second device entity may infer the terminal-related information or the terminal-related information and the related information of the second entity device by using the second processing method, to implement related processing. The terminal may report the terminal-related information to the first device entity through exchange in advance, or report the terminal-related information by using the second sub-information, and the first device entity obtains corresponding result information based on the terminal-related information by using the second processing method. The result information may be used to assist in accuracy of a handover policy and/or decision, and improve communication reliability of the terminal.

The first processing method and the second processing method may be the same, or may be mutually matched methods. Mutual matching may be understood as: an input of the first processing method may include at least a part of an output of the second processing method, and a corresponding result is obtained by using the first processing method.

It should be understood that the third processing method may be the first processing method or the second processing method. The third processing method may be understood as another processing method in another embodiment, for example, a processing method used to perform information feature hiding. When the third processing method is the first processing method, the first device entity may perform corresponding processing according to third sub-information reported by each terminal, for example, update information of the first processing method, and then send the update information to the terminal, so that the terminal updates the first processing method. It is assumed that when the third processing method is the second processing method, the first device entity may update the second processing method according to third information reported by each terminal.

In some embodiments, when the first information includes the indication used to request the third sub-information, the terminal may determine the third sub-information according to a beam measurement result of the terminal and the terminal-related information. Specifically, the beam measurement result and the terminal-related information may be used as the third sub-information, or the third processing method may be trained by using the beam measurement result and the terminal-related information, to obtain parameter information used to update the third processing method as the third sub-information. In this way, accuracy of the result information obtained through inference by using the third processing method can be improved.

In this embodiment of this application, a terminal receives first information sent by a first device entity; and the terminal performs a first operation according to the first information, where the first information includes at least one of the following: a service feature extraction request, where the service feature extraction request is used to indicate the terminal to perform the first operation based on a first processing method; first sub-information used to indicate the first processing method; first assistance information used for the first processing method; result information obtained by performing processing based on a second processing method; an indication used to request second sub-information, where the second sub-information includes terminal-related information or information obtained by performing information feature hiding on the terminal-related information; or an indication used to request third sub-information, where the third sub-information is used to update a third processing method. Because the terminal performs the first operation according to the first information, a handover policy and/or decision may be implemented by using the terminal-related information. In this embodiment of this application, communication reliability of the terminal is improved.

The following uses an example in which the first operation is a service feature extraction-related operation for description. The performing, by the terminal, a first operation according to the first information includes any one of the following:
performing, by the terminal, the service feature extraction-related operation based on the first processing method;
sending, by the terminal, the second sub-information or the third sub-information to the first device entity; or
performing, by the terminal, service feature extraction based on at least a part of information in the result information.

In this embodiment of this application, when the first information includes at least one of the service feature extraction request, the first sub-information used to indicate the first processing method, and the first assistance information for the first processing method, the first operation may include a service feature extraction-related operation and/or sending the second sub-information to the first device entity. When the first information includes the result information obtained performing processing based on the second processing method, the first operation may include: performing service feature extraction based on at least a part of information in the result information. When the first information includes the indication used to request the third sub-information, the first operation may include sending the third sub-information to the first device entity.

In some embodiments, the service feature extraction-related operation includes at least one of service prediction, service feature statistics, service feature key indicator extraction, or service experience statistics.

In some embodiments, an input of the second processing method includes the terminal-related information.

In some embodiments, the first assistance information meets any one of the following:
the first assistance information is obtained by performing first preset processing on first target information;
the first assistance information is the first target information; or
the first assistance information is the first target information in a case that the terminal performs authentication with the first device entity through a preset interaction authentication procedure, where
the first target information includes related information of a second device entity or information obtained by performing second preset processing on the related information of the second device entity.

In this embodiment of this application, the first device entity and the second device entity may be a same device entity, or may be different device entities. When the first device entity is different from the second device entity, the first device entity may first obtain the first target information. The following provides detailed description based on a case that the first device entity is different from the second device entity.

For example, the first device entity is a core network device, and the second device entity is a base station. The first device entity may send request information to the second device entity, to request the related information of the second device entity. The second device entity may directly send the related information of the second device entity to the first device entity, or may send the information to the first device entity after second preset processing is performed on the second device entity. In other words, the first device entity may send the first target information learned from the second device entity to the terminal, and may further process the first target information learned from the second device entity and send the processed information to the terminal.

The second preset processing includes at least one of the following: performing encryption processing or performing feature abstraction processing by using a preset neural network.

It should be understood that a processing manner of the second preset processing may be stipulated in the protocol or indicated by the first device entity. For example, the processing manner of the second preset processing may be indicated in the request information, or the processing manner of the second preset processing may be configured for the second device entity in advance before sending the request.

After receiving the first target information, the first device entity may send the first target information to the terminal as the first assistance information. In a case that the terminal performs authentication with the first device entity through a preset interaction procedure, the first target information may be sent to the terminal as the first assistance information. After the first preset processing is performed on the first target information, the first assistance information may be obtained, and then the first assistance information is sent to the terminal.

The processing manner of the first preset processing may be stipulated in the protocol, indicated by the terminal, or determined by the first device entity. This is not further limited herein. Specifically, in this embodiment of this application, the first preset processing includes at least one of the following: performing encryption processing or performing feature abstraction processing by using a preset neural network.

In some embodiments, the related information of the second device entity includes at least one of measurement information of the second device entity, implementation information of the second device entity, or statistics information of the second device entity.

In this embodiment of this application, the implementation information of the second device entity includes at least one of antenna configuration information of the second device entity, beam direction information of the second device entity, or location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

The terminal location information is highly correlated with a Channel State Information (CSI) result, a beam measurement result, and a radio resource management (RRM) measurement result, and can effectively assist in CSI prediction, motion track prediction, and the like.

In some embodiments, the related information of the second device entity includes at least one of the following: information about the terminal on a corresponding carrier or bandwidth part; statistics information of one terminal on a plurality of carriers or bandwidth parts; or statistics information of a plurality of terminals.

In some embodiments, the method further includes:
reporting, by the terminal, second assistance information to the first device entity, where the second assistance information includes at least one of a public key of the encryption processing or recommendation information of a network parameter of the preset neural network,

In this embodiment of this application, the first information includes the indication used to request the second sub-information, and the second sub-information is the information obtained by performing information feature hiding on the terminal-related information. After obtaining the second assistance information, the first device entity may send the second assistance information to the second device entity. In some embodiments, the terminal may further directly send the second assistance information to the second device entity. The second device entity may perform a corresponding processing operation based on the second assistance information. For example, after performing the second preset processing (for example, encryption processing) on the related information of the second device entity, the second device entity sends the processed first target information to the first device entity.

In some embodiments, the method further includes:
communicating, by the terminal, with the first device entity to determine at least one of the following:
whether the terminal has a capability of performing a service prediction operation based on the first processing method;
available terminal-related information when the terminal performs the service prediction operation; or
a probability of performing different types of service transmission within a preset time period.

In this embodiment of this application, the first device entity may communicate with the terminal to determine specific content of the first information. For example, the terminal may directly send related information, or the first device entity sends a request, and the terminal feeds back the related information to the first device entity based on the request.

In some embodiments, the terminal-related information includes at least one of the following: location information, occupational or social state information, social relationship network information, historical service information, current service state information, or physiological indicator information. The social relationship network information, the historical service information, the current service state information, and the physiological indicator information may be understood as terminal local information or terminal privacy information. Because this information is added, prediction is assisted, and transmission reliability of the terminal is further improved.

The preset time period may be understood as a future time period. The different types of services may be determined based on features such as an average rate, a delay, and a periodicity of a service, or may be determined based on another specific identifier, such as an XR service, a video service, and an audio service.

In some embodiments, a manner of performing information feature hiding includes at least one of the following:
performing encryption processing or performing feature abstraction processing by using a preset neural network.

In this embodiment of this application, the terminal-related information on which information feature hiding is performed does not support restoration or cannot recover original information within a predefined time, or whether the terminal-related information on which information feature hiding is performed supports restoration is stipulated in the protocol, or indicated by the first device entity or the terminal.

In some embodiments, in a case that the first information includes the result information obtained by performing processing based on the second processing method, the method further includes:
sending, by the terminal, second information to the first device entity, where the second information includes at least one of the following:
information used to determine the second processing method; or
recommendation information of a network parameter of a second neural network in a case that the second processing method is a method for processing by using the second neural network.

In this embodiment of this application, the first device entity may perform corresponding inference based on the second information sent by the terminal, the information obtained after feature hiding is performed on the terminal-related information, and at least a part of information in the related information of the second device entity as the input of the second processing method, to obtain the foregoing result information,

After receiving the result information, the terminal may perform further processing in a predefined manner, and send a corresponding processing result to the first device entity or the second device entity. For example, the first device entity performs processing on encrypted data, and cannot interpret the processing result. The terminal only knows private key information, and decrypts the processed data.

In some embodiments, the second sub-information includes information obtained by aggregating the terminal-related information with related information of a second device entity, or information obtained by performing information feature hiding on the information obtained by aggregating the terminal-related information with the related information of the second device entity.

In this embodiment, the terminal may obtain the related information of the second device entity in advance. In this case, the related information of the second device entity may be information on which information feature hiding is not performed, or may be information on which information feature hiding is performed. This is not further limited herein. In a case that the terminal receives the indication used to request the second sub-information, the terminal may aggregate the related information of the second device entity and the terminal-related information to obtain the second sub-information, and then send the second sub-information to the first device entity, so that the first device entity performs corresponding processing, for example, performs inference by using the second processing method.

In a case that the third processing method includes a method for processing by using a third neural network and the first information is the indication used to request the third sub-information, after the receiving, by a terminal, first information sent by a first device entity, the method further includes:
sending, by the terminal, the third sub-information to the first device entity, where the third sub-information is network parameter update information of the third neural network.

In this embodiment of this application, when the third processing method is the first processing method, the third neural network may be understood as the first neural network. In this case, the first device entity may perform corresponding processing according to third sub-information reported by each terminal to obtain network parameter update information, and send the network parameter update information to the terminal for updating. In this case, the network parameter update information may be carried in the first sub-information.

When the third processing method is the second processing method, the third neural network may be understood as a second neural network associated with the second processing method, and the first device entity may update the second neural network according to third information reported by each terminal.

In some embodiments, the network parameter update information is obtained by training the third neural network based on terminal association information and terminal implementation.

To better understand this application, the following is described in detail by using some specific examples by assuming that the first device entity is different from the second device, and the second device entity is a base station,

Embodiment 1: including the following procedures:

Step 1: A first device entity requests service prediction data from a terminal, and performs the following behavior before this or at the same time:

The terminal exchanges, by using signaling, with the first device entity whether there is a corresponding capability.

The terminal may exchange “privacy information used for calculation when the terminal locally performs service prediction” with the first device entity by using signaling, which may include information such as location information, personal service data history information (including information such as personal service browsing), occupational/social state information, a social network, and a physiological indicator

The terminal exchanges an expected output with the first device entity by using signaling. The possible outputs include a probability of performing different types of services in a future predefined time period, where a corresponding service type includes features such as an average rate, a delay, and a periodicity of a service. A specific service type may also provide another specific identifier, such as an XR service, a video service, and an audio service.

The first device entity sends, to the terminal by using signaling, corresponding neural network information (that is, the foregoing first sub-information) used for prediction,

Step 2: The terminal performs service prediction based on local information by using the neural network information sent by the first device entity.

Step 3: The terminal reports a service prediction result.

Embodiment 2: including the following procedures:

Step 1: A first device entity requests service prediction data from a terminal, and performs the following behavior before this or at the same time:

The first device entity proposes corresponding requirement data information to the terminal, where the information may include information such as location information, personal service data history information (including information such as personal service browsing), occupational/social state information, a social network, and a physiological indicator.

The first device entity may send, to the terminal, some predefined representative information of a type of an abstract feature obtained after the foregoing information is combined, and it is difficult for the abstract representative information to directly restore corresponding original information.

The representative information of the abstract feature may be information formed after the original information is processed by a predetermined neural network. The first device entity knows that the neural network exists, but cannot learn details of the neural network. Thus, the original information cannot be recovered from the abstract data.

Step 2: The terminal performs information feature hiding on corresponding information and then sends the information to the first device entity, and/or a base station sends corresponding assistance information to the first device entity.

Information feature hiding includes encryption, performing a complex operation on information, information abstraction, and the like, and therefore it is impossible or it is expensive to recover corresponding original data.

In some embodiments, the assistance information includes: how to process data on which information hiding is performed and/or how to perform processing in combination with other data.

For example, the assistance information may be a public key used for encryption. To facilitate homomorphic encryption processing, the first device entity needs to perform same encryption processing on other information when jointly processing terminal feedback information and the other information. In addition, the assistance information may be neural network parameter recommendation information that needs to be further processed.

Step 3: The first device entity performs processing according to the assistance information sent by the terminal, information on which information feature hiding is performed, and/or other information (for example, information obtained from an entity 3).

Step 4: The first device entity may send further processed information to the terminal. After performing further processing in a predefined manner, the terminal sends the corresponding processed information to the first device entity or the base station. For example, the first device entity performs processing on encrypted data, and cannot interpret the processing result. The terminal only knows private key information, and decrypts the processed data.

Referring to FIG. 3, FIG. 3 is a flowchart of another information processing method according to an embodiment of this application. As shown in FIG. 3, the method includes the following steps:

Step 301: A first device entity sends first information to a terminal.

The first information is used to trigger the terminal to perform a first operation, and the first information includes at least one of the following:
a service feature extraction request, where the service feature extraction request is used to indicate the terminal to perform the first operation based on a first processing method;
first sub-information used to indicate the first processing method;
first assistance information used for the first processing method;
result information obtained by performing processing based on a second processing method;
an indication used to request second sub-information, where the second sub-information includes terminal-related information or information obtained by performing information feature hiding on the terminal-related information; or
an indication used to request third sub-information, where the third sub-information is used to update a third processing method.

In some embodiments, the first operation is a service feature extraction-related operation.

In some embodiments, the service feature extraction-related operation includes at least one of service prediction, service feature statistics, service feature key indicator extraction, or service experience statistics.

In some embodiments, an input of the second processing method includes the terminal-related information.

In some embodiments, the first assistance information meets any one of the following:
the first assistance information is obtained by performing first preset processing on first target information;
the first assistance information is the first target information; or
the first assistance information is the first target information in a case that the terminal performs authentication with the first device entity through a preset interaction authentication procedure, where the first target information includes related information of a second device entity or
information obtained by performing second preset processing on the related information of the second device entity.

In some embodiments, the related information of the second device entity includes at least one of measurement information of the second device entity, implementation information of the second device entity, or statistics information of the second device entity.

In some embodiments, the implementation information of the second device entity includes at least one of antenna configuration information of the second device entity, beam direction information of the second device entity, or location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

In some embodiments, the related information of the second device entity includes at least one of the following: information about the terminal on a corresponding carrier or bandwidth part; statistics information of one terminal on a plurality of carriers or bandwidth parts; or statistics information of a plurality of terminals.

In some embodiments, the first preset processing includes at least one of the following: performing encryption processing or performing feature abstraction processing by using a preset neural network.

In some embodiments, the method further includes:
receiving, by the first device entity, second assistance information reported by the terminal, where the second assistance information includes at least one of a public key of the encryption processing or recommendation information of a network parameter of the preset neural network.

In some embodiments, the second preset processing includes at least one of the following: performing encryption processing or performing feature abstraction processing by using a preset neural network.

In some embodiments, the second device entity is configured to provide a network service for the terminal, and the second device entity is a base station, a core network device, or another network element other than the base station and the core network device.

In some embodiments, the first processing method includes a method for processing by using a first neural network, and the first sub-information includes neural network-related information of the first neural network.

In some embodiments, the neural network-related information includes at least one of a structure of the neural network or a parameter of the neural network.

In some embodiments, the first device entity includes one or at least two of the following: a base station, a local management function LMF, a network data analytics function NWDAF, a first network element, and a second network element, where the first network element is a network element configured to perform the second processing method, and the second network element is configured to perform at least one of the following: performing information collection on information required by the second processing method, or performing information calculation on the information required by the second processing method.

In some embodiments, the method further includes:
communicating, by the first device entity, with the terminal to determine at least one of the following:
whether the terminal has a capability of performing a service prediction operation based on the first processing method;
available terminal-related information when the terminal performs the service prediction operation; or
a probability of performing different types of service transmission within a preset time period.

In some embodiments, a manner of performing information feature hiding includes at least one of the following:
performing encryption processing or performing feature abstraction processing by using a preset neural network.

In a case that the first information includes the result information obtained by performing processing based on the second processing method, the method further includes:
receiving, by the first device entity, second information sent by the terminal, where the second information includes at least one of the following:
information used to determine the second processing method; or
recommendation information of a network parameter of a second neural network in a case that the second processing method is a method for processing by using the second neural network.

In some embodiments, the first preset processing includes at least one of the following: performing encryption processing or performing feature abstraction processing by using a preset neural network.

In some embodiments, the method further includes:
receiving, by the first device entity, second assistance information sent by the terminal, where the second assistance information includes at least one of a public key of the encryption processing or recommendation information of a network parameter of the preset neural network.

In some embodiments, after the receiving, by the first device entity, second assistance information sent by the terminal, the method further includes:
sending, by the first device entity, the second assistance information to a second device entity.

In some embodiments, the terminal-related information includes at least one of the following: location information, occupational or social state information, social relationship network information, historical service information, current service state information, or physiological indicator information.

In some embodiments, the second sub-information includes information obtained by aggregating the terminal-related information with related information of a second device entity, or information obtained by performing information feature hiding on the information obtained by aggregating the terminal-related information with the related information of the second device entity.

In a case that the third processing method includes a method for processing by using a third neural network and the first information is the indication used to request the third sub-information, after the sending, by a first device entity, first information to a terminal, the method further includes:
receiving, by the first device entity, the third sob-information sent by the terminal, where the third sub-information is network parameter update information of the third neural network.

In some embodiments, the network parameter update information is obtained by training the third neural network based on terminal association information and terminal implementation.

It should be noted that this embodiment is used as an implementation of the first device entity corresponding to the embodiment shown in FIG. 2. For a specific implementation of this embodiment, refer to the related descriptions of the embodiment shown in FIG. 2. A same effect can also be achieved. To avoid repeated descriptions, details are not described again herein.

Referring to FIG. 4, FIG. 4 is a flowchart of another information processing method according to an embodiment of this application. As shown in FIG. 4, the method includes the following steps:

Step 401: A second device entity sends first target information to a first device entity, where the first target information includes related information of the second device entity or information obtained by performing second preset processing on the related information of the second device entity, and the first target information is used to determine first information sent by the first device entity to a terminal,

The first information is used to trigger the terminal to perform a first operation, and the first information includes at least one of the following:
first sub-information used to indicate the first processing method;
first assistance information used for the first processing method; or
result information obtained by performing processing based on a second processing method.

In some embodiments, the first operation is a service feature extraction-related operation.

In some embodiments, the service feature extraction-related operation includes at least one of service prediction, service feature statistics, service feature key indicator extraction, or service experience statistics.

In some embodiments, before the sending, by a second device entity, first target information to a first device entity, the method further includes:
receiving, by the second device entity, a first request sent by the first device entity, where the first request is used to obtain the related information of the second device entity.

In some embodiments, an input of the second processing method includes the terminal-related information.

In some embodiments, the first assistance information meets any one of the following:
the first assistance information is obtained by performing first preset processing on first target information;
the first assistance information is the first target information; or
the first assistance information is the first target information in a case that the terminal performs authentication with the first device entity through a preset interaction authentication procedure, where
the first target information includes related information of a second device entity or information obtained by performing second preset processing on the related information of the second device entity.

In some embodiments, the related information of the second device entity includes at least one of measurement information of the second device entity, implementation information of the second device entity, or statistics information of the second device entity.

In some embodiments, the implementation. information of the second device entity includes at least one of antenna configuration information of the second device entity, beam direction information of the second device entity, or location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

In some embodiments, the related information of the second device entity includes at least one of the following: information about the terminal on a corresponding carrier or bandwidth part; statistics information of one terminal on a plurality of carriers or bandwidth parts; or statistics information of a plurality of terminals.

In some embodiments, the first preset processing includes at least one of the following: performing encryption processing or performing feature abstraction processing by using a preset neural network.

In some embodiments, the method further includes:
receiving, by the second device entity, second assistance information sent by the first device entity or the terminal, where the second assistance information includes at least one of a public key of the encryption processing or recommendation information of a network parameter of the preset neural network.

In some embodiments, the second preset processing includes at least one of the following: performing encryption processing or performing feature abstraction processing by using a preset neural network.

In some embodiments, the second device entity is configured to provide a network service for the terminal, and the second device entity is a base station, a core network device, or another network element other than the base station and the core network device.

In some embodiments, the first processing method includes a method for processing by using a first neural network, and the first sub-information includes neural network-related information of the first neural network.

In some embodiments, the neural network-related information includes at least one of a structure of the neural network or a parameter of the neural network.

In some embodiments, the first device entity includes one or at least two of the following: a base station, a local management function LMF, a network data analytics function NWDAF, a first network element, and a second network element, where the first network element is a network element configured to perform the second processing method, and the second network element is configured to perform at least one of the following: performing information collection on information required by the second processing method, or performing information calculation on the information required by the second processing method.

It should be noted that this embodiment is used as an implementation of the second device entity corresponding to the embodiment shown in FIG. 2. For a specific implementation of this embodiment, refer to the related descriptions of the embodiment shown in FIG. 2. A same effect can also be achieved. To avoid repeated descriptions, details are not described again herein.

It should be noted that the information processing method provided in the embodiments of this application may be performed by an information processing apparatus, or a control module that is in the information processing apparatus and that is configured to perform the information processing method, in the embodiments of this application, that the information processing apparatus performs the information processing method is used as an example to describe the information processing apparatus provided in the embodiments of this application.

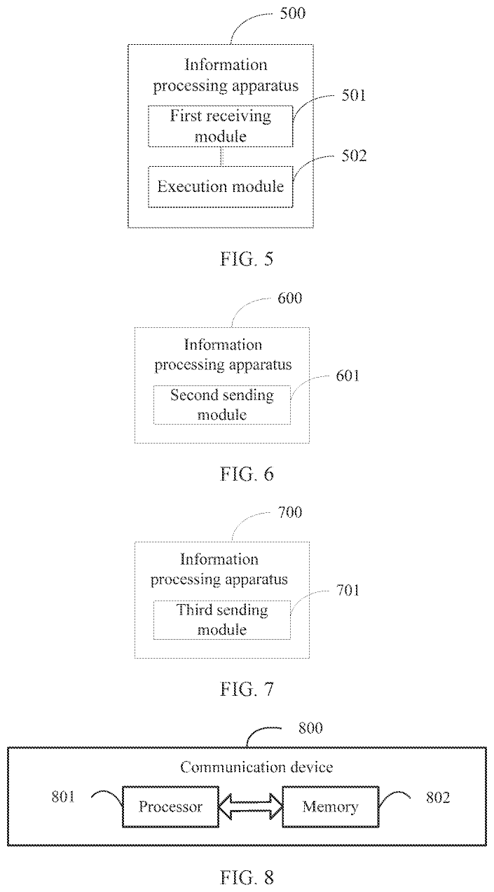

Referring to FIG. 5, FIG. 5 is a structural diagram of an information processing apparatus according to an embodiment of this application. As shown in FIG. 5, an information processing apparatus 500 includes:
a first receiving module 501, configured to receive first information sent by a first device entity; and
an execution module 502, configured to perform a first operation according to the first information, where
the first information includes at least one of the following:
a service feature extraction request, where the service feature extraction request is used to indicate a terminal to perform the first operation based on a first processing method;
first sub-information used to indicate the first processing method;
first assistance information used for the first processing method;
result information obtained by performing processing based on a second processing method;
an indication used to request second sub-information, where the second sub-information includes terminal-related information or information obtained by performing information feature hiding on the terminal-related information; and
an indication used to request third sub-information, where the third sub-information is used to update a third processing method.

In some embodiments, the first operation is a service feature extraction-related operation.

In some embodiments, the execution module 502 is configured to perform any one of the following:
performing the service feature extraction-related operation based on the first processing method;
sending the second sub-information or the third sub-information to the first device entity; and
performing service feature extraction based on at least a part of information in the result information.

In some embodiments, the service feature extraction-related operation includes at least one of service prediction, service feature statistics, service feature key indicator extraction, and service experience statistics.

In some embodiments, an input of the second processing method includes the terminal-related information.

In some embodiments, the first assistance information meets any one of the following:
the first assistance information is obtained by performing first preset processing on first target information;
the first assistance information is the first target information; and
the first assistance information is the first target information in a case that the terminal performs authentication with the first device entity through a preset interaction authentication procedure, where
the first target information includes related information of a second device entity or information obtained by performing second preset processing on the related information of the second device entity.

In some embodiments, the related information of the second device entity includes at least one of measurement information of the second device entity, implementation information of the second device entity, and statistics information of the second device entity.

In some embodiments, the implementation. information of the second device entity includes at least one of antenna configuration information of the second device entity, beam direction information of the second device entity, and location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

In some embodiments, the related information of the second device entity includes at least one of the following: information about the terminal on a corresponding carrier or bandwidth part; statistics information of one terminal on a plurality of carriers or bandwidth parts; and statistics information of a plurality of terminals.

In some embodiments, the first preset processing includes at least one of the following: performing encryption processing and performing feature abstraction processing by using a preset neural network.

In some embodiments, the information processing apparatus 500 further includes:
a first sending module, configured to report second assistance information to the first device entity, where the second assistance information includes at least one of a public key of the encryption processing and recommendation information of a network parameter of the preset neural network.

In some embodiments, the second preset processing includes at least one of the following: performing encryption processing and performing feature abstraction processing by using a preset neural network.

In some embodiments, the second device entity is configured to provide a network service for the terminal, and the second device entity is a base station, a core network device, or another network element other than the base station and the core network device.

In some embodiments, the first processing method includes a method for processing by using a first neural network, and the first sub-information includes neural network-related information of the first neural network.

In some embodiments, the neural network-related information includes at least one of a structure of the neural network and a parameter of the neural network.

In some embodiments, the first device entity includes one or at least two of the following: a base station, a local management function LMF, a network data analytics function NWDAF, a first network element, and a second network element, where the first network element is a network element configured to perform the second processing method, and the second network element is configured to perform at least one of the following: performing information collection on information required by the second processing method, and performing information calculation on the information required by the second processing method.

In some embodiments, the information processing apparatus 500 further includes:
a first interaction module, configured to communicate with the first device entity to determine at least one of the following:
whether the terminal has a capability of performing a service prediction operation based on the first processing method;
available terminal-related information when the terminal performs the service prediction operation; and
a probability of performing different types of service transmission within a preset time period.

In some embodiments, a trimmer of performing information feature hiding includes at least one of the following:
performing encryption processing and performing feature abstraction processing by using a preset neural network.

In a case that the first information includes the result information obtained by performing processing based on the second processing method, the information processing apparatus 500 further includes:
a first sending module, configured to send second information to the first device entity, where the second information includes at least one of the following:
information used to determine the second processing method; and
recommendation information of a network parameter of a second neural network in a case that the second processing method is a method for processing by using the second neural network.

In some embodiments, the terminal-related information includes at least one of the following: location information, occupational or social state information, social relationship network information, historical service information, current service state information, and physiological indicator information.

In some embodiments, the second sub-information includes information obtained by aggregating the terminal-related information with related information of a second device entity, or information obtained by performing information feature hiding on the information obtained by aggregating the terminal-related information with the related information of the second device entity.

In a case that the third processing method includes a method for processing by using a third neural network and the first information is the indication used to request the third sub-information, the information processing apparatus further includes:
a first sending module, configured to send the third sub-information to the first device entity, where the third sub-information is network parameter update information of the third neural network.

In some embodiments, the network parameter update information is obtained by training the third neural network based on terminal association information and terminal implementation.

The information processing apparatus provided in this embodiment of this application can implement the processes in the method embodiment in FIG. 2. To avoid repetition, details are not described herein again.

Referring to FIG. 6, FIG. 6 is a structural diagram of an information processing apparatus according to an embodiment of this application. As shown in FIG. 6, an information processing apparatus 600 includes:
a second sending module 601, configured to send first information to a terminal, where
the first information is used to trigger the terminal to perform a first operation, and the first information includes at least one of the following:
a service feature extraction request, where the service feature extraction request is used to indicate the terminal to perform the first operation based on a first processing method;
first sub-information used to indicate the first processing method;
first assistance information used for the first processing method;
result information obtained by performing processing based on a second processing method;
an indication used to request second sub-information, where the second sub-information includes terminal-related information or information obtained by performing information feature hiding on the terminal-related information; and
an indication used to request third sub-information, where the third sub-information is used to update a third processing method.

In some embodiments, the first operation is a service feature extraction-related operation.

In some embodiments, the service feature extraction-related operation includes at least one of service prediction, service feature statistics, service feature key indicator extraction, and service experience statistics.

In some embodiments, an input of the second processing method includes the terminal-related information.

In some embodiments, the first assistance information meets any one of the following:
the first assistance information is obtained by performing first preset processing on first target information;
the first assistance information is the first target information and
the first assistance information is the first target information in a case that the terminal performs authentication with the first device entity through a preset interaction authentication procedure, where
the first target information includes related information of a second device entity or information obtained by performing second preset processing on the related information of the second device entity.

In some embodiments, the related information of the second device entity includes at least one of measurement information of the second device entity, implementation information of the second device entity, and statistics information of the second device entity.

In some embodiments, the implementation information of the second device entity includes at least one of antenna configuration information of the second device entity, beam direction information of the second device entity, and location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

In some embodiments, the related information of the second device entity includes at least one of the following: information about the terminal on a corresponding carrier or bandwidth part; statistics information of one terminal on a plurality of carriers or bandwidth parts; and statistics information of a plurality of terminals.

In some embodiments, the first preset processing includes at least one of the following: performing encryption processing and performing feature abstraction processing by using a preset neural network.

In some embodiments, the information processing apparatus 600 further includes:
a second receiving module, configured to receive second assistance information reported by the terminal, where the second assistance information includes at least one of a public key of the encryption processing and recommendation information of a network parameter of the preset neural network.

In some embodiments, the second preset processing includes at least one of the following: performing encryption processing and performing feature abstraction processing by using a preset neural network.

In some embodiments, the second device entity is configured to provide a network service for the terminal, and the second device entity is a base station, a core network device, or another network element other than the base station and the core network device.

In some embodiments, the first processing method includes a method for processing by using a first neural network, and the first sub-information includes neural network-related information of the first neural network.

In some embodiments, the neural network-related information includes at least one of a structure of the neural network and a parameter of the neural network.

In some embodiments, the first device entity includes one or at least two of the following: a base station, a local management function LMF, a network data analytics function NWDAF, a first network element, and a second network element, where the first network element is a network element configured to perform the second processing method, and the second network element is configured to perform at least one of the following: performing information collection on information required by the second processing method, and performing information calculation on time information required by the second processing method.

In some embodiments, the information processing apparatus 600 further includes:
a second interaction module, configured to communicate with the terminal to determine at least one of the following:
whether the terminal has a capability of performing a service prediction operation based on the first processing method;
available terminal-related information when the terminal performs the service prediction operation; and
a probability of performing different types of service transmission within a preset time period.

In some embodiments, a manner of performing information feature hiding includes at least one of the following:
performing encryption processing and performing feature abstraction processing by using a preset neural network.

In a case that the first information includes the result information obtained by performing processing based on the second processing method, the information processing apparatus further includes:
a second receiving module, configured to receive second information sent by the terminal, where the second information includes at least one of the following:
information used to determine the second processing method; and
recommendation information of a network parameter of a second neural network in a case that the second processing method is a method for processing by using the second neural network.

In some embodiments, the first preset processing includes at least one of the following: performing encryption processing and performing feature abstraction processing by using a preset neural network.

In some embodiments, the information processing apparatus 600 further includes:
a second receiving module, configured to receive second assistance information sent by the terminal, where the second assistance information includes at least one of a public key of the encryption processing and recommendation information of a network parameter of the preset neural network.

In some embodiments, after the receiving, by the first device entity, second assistance information sent by the terminal, the second sending module is further configured to send the second assistance information to a second device entity.

In some embodiments, the terminal-related information includes at least one of the following: location information, occupational or social state information, social relationship network information, historical service information, current service state information, and physiological indicator information.

In some embodiments, the second sub-information includes information obtained by aggregating the terminal-related information with related information of a second device entity, or information obtained by performing information feature hiding on the information obtained by aggregating the terminal-related information with the related information of the second device entity.

In a case that the third processing method includes a method for processing by using a third neural network and the first information is the indication used to request the third sub-information, other the sending, by a first device entity, first information to a terminal, the information processing apparatus 600 further includes:
a second receiving module, configured to receive the third sub-information sent by the terminal, where the third sub-information is network parameter update information of the third neural network.

In some embodiments, the network parameter update information is obtained by training the third neural network based on terminal association information and terminal implementation.

The information processing apparatus provided in this embodiment of this application can implement the processes in the method embodiment in FIG. 3. To avoid repetition, details are not described herein again.

Referring to FIG. 7, FIG. 7 is a structural diagram of an information processing apparatus according to an embodiment of this application. As shown in FIG. 7, an information processing apparatus 700 includes:
a third sending module 701, configured to send first target information to a first device entity, where the first target information includes related information of the second device entity or information obtained by performing second preset processing on the related information of the second device entity, and the first target information is used to determine first information sent by the first device entity to a terminal, where
the first information is used to trigger the terminal to perform a first operation, and the first information includes at least one of the following:
first sub-information used to indicate the first processing method;
first assistance information used for the first processing method; and
result information obtained by performing processing based on a second processing method.

In some embodiments, the first operation is a service feature extraction-related operation.

In some embodiments, the service feature extraction-related operation includes at least one of service prediction, service feature statistics, service feature key indicator extraction, and service experience statistics.

In some embodiments, the information processing apparatus 700 further includes:
a third receiving module, configured to receive a first request sent by the first device entity, where the first request is used to obtain the related information of the second device entity.

In some embodiments, an input of the second processing method includes the terminal-related information.

In some embodiments, the first assistance information meets any one of the following:
the first assistance information is obtained by performing first preset processing on first target information;
the first assistance information is the first target information; and
the first assistance information is the first target information in a case that the terminal performs authentication with the first device entity through a preset interaction authentication procedure, where
the first target information includes related information of a second device entity or information obtained by performing second preset processing on the related information of the second device entity.

In some embodiments, the related information of the second device entity includes at least one of measurement information of the second device entity, implementation information of the second device entity, and statistics information of the second device entity.

In some embodiments, the implementation information of the second device entity includes at least one of antenna configuration information of the second device entity, beam direction information of the second device entity, and location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

In some embodiments, the related information of the second device entity includes at least one of the following: information about the terminal on a corresponding carrier or bandwidth part; statistics information of one terminal on a plurality of carriers or bandwidth parts; and statistics information of a plurality of terminals.

In some embodiments, the first preset processing includes at least one of the following: performing encryption processing and performing feature abstraction processing by using a preset neural network.

In some embodiments, the information processing apparatus further includes:
a third receiving module, configured to receive second assistance information sent by the first device entity or the terminal, where the second assistance information includes at least one of a public key of the encryption processing and recommendation information of a network parameter of the preset neural network.

In some embodiments, the second preset processing includes at least one of the following: performing encryption processing and performing feature abstraction processing by using a preset neural network.

In some embodiments, the second device entity is configured to provide a network service for the terminal, and the second device entity is a base station, a core network device, or another network element other than the base station and the core network device.

In some embodiments, the first processing method includes a method for processing by using a first neural network, and the first sub-information includes neural network-related information of the first neural network.

In some embodiments, the neural network-related information includes at least one of a structure of the neural network and a parameter of the neural network.

In some embodiments, the first device entity includes one or at least two of the following: a base station, a local management function LMF, a network data analytics function NWDAF, a first network element, and a second network element, where the first network element is a network element configured to perform the second processing method, and the second network element is configured to perform at least one of the following: performing information collection on information required by the second processing method, and performing information calculation on the information required by the second processing method.

The information processing apparatus provided in this embodiment of this application can implement the processes in the method embodiment in FIG. 4. To avoid repetition, details are not described herein again.

The information processing apparatus in this embodiment of this application may be an apparatus, an apparatus or an electronic device with an operating system, or may be a component, an integrated circuit, or a chip in a terminal. The apparatus may be a mobile terminal, or a non-mobile terminal. For example, the mobile device may include but is not limited to the types of the terminal 11 listed above, and the non-mobile terminal may be a server, a Network Attached Storage (NAS), a Personal Computer (PC), a Television (TV), an automated teller machine, or a self-service machine. This is not specifically limited in the embodiments of this application.

The information processing apparatus provided in this embodiment of this application can implement the processes implemented in the method embodiments in FIG. 2 to FIG. 4, and achieve a same technical effect. To avoid repetition, details are not described herein again.

In some embodiments, as shown in FIG. 8, an embodiment of this application further provides a communication device 800, including a processor 801, a memory 802, and a program or an instruction that is stored in the memory 802 and that can be run on the processor 801, where the program or the instruction is executed by the processor 801 to implement the processes of the foregoing information processing method embodiment, and a same technical effect can be achieved. To avoid repetition, details are not described herein again.

An embodiment of this application further provides a terminal, including a processor and a communication interface. The communication interface is configured to receive first information sent by a first device entity.

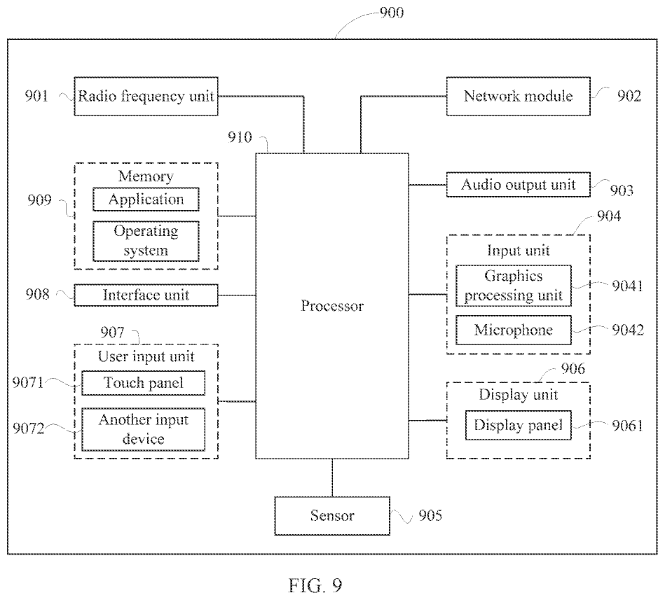

The processor is configured to perform a first operation according to the first information, where
the first information includes at least one of the following:
a service feature extraction request, where the service feature extraction request is used to indicate the terminal to perform the first operation based on a first processing method;
first sub-information used to indicate the first processing method;
first assistance information used for the first processing method;
result information obtained by performing processing based on a second processing method;
an indication used to request second sub-information, where the second sub-information includes terminal-related information or information obtained by performing information feature hiding on the terminal-related information; and
an indication used to request third sub-information, where the third sub-information is used to update a third processing method. This terminal embodiment corresponds to the foregoing method embodiment on the terminal side. Each implementation process and implementation of the foregoing method embodiment may be applicable to this terminal embodiment, and a same technical effect can be achieved. FIG. 9 is a schematic structural diagram of hardware of a terminal according to the embodiments of this application.

A terminal 900 includes but is not limited to at least a part of components such as a radio frequency unit 901, a network module 902, an audio output unit 903, an input unit 904, a sensor 905, a display unit 906, a user input unit 907, an interface unit 908, a memory 909, and a processor 910.

A person skilled in the art can understand that the terminal 900 may further include a power supply (such as a battery) that supplies power to each component. The power supply may be logically connected to the processor 910 by using a power supply management system, to implement functions such as charging and discharging management, and power consumption management by using the power supply management system. The terminal structure shown in FIG. 9 constitutes no limitation on the terminal, and the terminal may include more or fewer components than those shown in the figure, or combine some components, or have different component arrangements. Details are not described herein.

It should be understood that, in this embodiment of this application, the input unit 904 may include a Graphics Processing Unit (GPU) 9041 and a microphone 9042, and the graphics processing unit 9041 processes image data of a still picture or a video obtained by an image capture apparatus (such as a camera) in a video capture mode or an image capture mode. The display unit 906 may include a display panel 9061. In some embodiments, the display panel 9061 may be configured in a form such as a liquid crystal display or an organic light-emitting diode. The user input unit 907 includes a touch panel 9071 and another input device 9072. The touch panel 9071 is also referred to as a touchscreen. The touch panel 9071 may include two parts: a touch detection apparatus and a touch controller. The another input device 9072 may include but is not limited to a physical keyboard, a functional button (such as a volume control button or a power on/off button), a trackball, a mouse, and a joystick. Details are not described herein.

In this embodiment of this application, the radio frequency unit 901 receives downlink data from a network side device and then sends the downlink data to the processor 910 for processing; and sends uplink data to the network side device. Usually, the radio frequency unit 901 includes but is not limited to an antenna, at least one amplifier, a transceiver, a coupler, a low noise amplifier, a duplexer, and the like.

The memory 909 may be configured to store a software program or an instruction and various data. The memory 109 may mainly include a program or instruction storage area and a data storage area. The program or instruction storage area may store an operating system, and an application or an instruction required by at least one function (for example, a sound playing function or an image playing function). In addition, the memory 909 may include a high-speed random access memory, and may further include a non-transient memory. The non-transient memory may be a Read-Only Memory (ROM), a Programmable ROM (PROM), an Erasable PROM (EPROM), an Electrically EPROM (EEPROM), or a flash memory, for example, at least one disk storage component, a flash memory component, or another non-transient solid-state storage component.

The processor 910 may include one or more processing units. In some embodiments, an application processor and a modem processor may be integrated into the processor 910. The application processor mainly processes an operating system, a user interface, an application, an instruction, or the like. The modem processor mainly processes wireless communication, for example, a baseband processor. It can be understood that, the modem processor may not be integrated into the processor 910.

The radio frequency unit 901 is configured to receive first information sent by a first device entity.

The processor 910 is configured to perform a first operation according to the first information, where
the first information includes at least one of the following:
a service feature extraction request, where the service feature extraction request is used to indicate a terminal to perform the first operation based on a first processing method;
first sub-information used to indicate the first processing method;

first assistance information used for the first processing method;
result information obtained by performing processing based on a second processing method;
an indication used to request second sub-information, where the second sub-information includes terminal-related information or information obtained by performing information feature hiding on the terminal-related information; and
an indication used to request third sub-information, where the third sub-information is used to update a third processing method.

In some embodiments, the first operation is a service feature extraction-related operation.

In some embodiments, the processor 910 is configured to perform any one of the following:
performing the service feature extraction-related operation based on the first processing method:
sending the second sub-information or the third sub-information to the first device entity; and
performing service feature extraction based on at least a part of information in the result information.

In some embodiments, the service feature extraction-related operation includes at least one of service prediction, service feature statistics, service feature key indicator extraction, and service experience statistics.

In some embodiments, an input of the second processing method includes the terminal-related information.

In some embodiments, the first assistance information meets any one of the following:
the first assistance information is obtained by performing first preset processing on first target information;
the first assistance information is the first target information; and
the first assistance information is the first target information in a case that the terminal performs authentication with the first device entity through a preset interaction authentication procedure, where
the first target information includes related information of a second device entity or information obtained by performing second preset processing on the related information of the second device entity.

In some embodiments, the related information of the second device entity includes at least one of measurement information of the second device entity, implementation information of the second device entity, and statistics information of the second device entity.

In some embodiments, the implementation information of the second device entity includes at least one of antenna configuration information of the second device entity, beam direction information of the second device entity, and location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

In some embodiments, the related information of the second device entity includes at least one of the following: information about the terminal on a corresponding carrier or bandwidth part; statistics information of one terminal on a plurality of carriers or bandwidth parts; and statistics information of a plurality of terminals.

In some embodiments, the first preset processing includes at least one of the following: performing encryption processing and performing feature abstraction processing by using a preset neural network.

In some embodiments, the radio frequency unit 901 is further configured to report second assistance information to the first device entity, where the second assistance information includes at least one of a public key of the encryption processing and recommendation information of a network parameter of the preset neural network.

In some embodiments, the second preset processing includes at least one of the following: performing encryption processing and performing feature abstraction processing by using a preset neural network.

In some embodiments, the second device entity is configured to provide a network service for the terminal, and the second device entity is a base station, a core network device, or another network element other than the base station and the core network device.

In some embodiments, the first processing method includes a method for processing by using a first neural network, and the first sub-information includes neural network-related information of the first neural network.

In some embodiments, the neural network-related information includes at least one of a structure of the neural network and a parameter of the neural network.

In some embodiments, the first device entity includes one or at least two of the following: a base station, a local management function LMF, a network data analytics function NWDAF, a first network element, and a second network element, where the first network element is a network element configured to perform the second processing method, and the second network element is configured to perform at least one of the following: performing information collection on information required by the second processing method, and performing information calculation on the information required by the second processing method.

In some embodiments, the radio frequency unit 901 is further configured to communicate with the first device entity to determine at least one of the following:
whether the terminal has a capability of performing a service prediction operation based on the first processing method;
available terminal-related information when the terminal performs the service prediction operation; and
a probability of performing different types of service transmission within a preset time period.

In some embodiments, a manner of performing information feature hiding includes at least one of the following:
performing encryption processing and performing feature abstraction processing by using a preset neural network.

In some embodiments, the radio frequency unit 901 is further configured to: in a case that the first information includes the result information obtained by performing processing based on the second processing method, send second information to the first device entity, where the second information includes at least one of the following:
information used to determine the second processing method; and
recommendation information of a network parameter of a second neural network in a case that the second processing method is a method for processing by using the second neural network.

In some embodiments, the terminal-related information includes at least one of the following: location information, occupational or social state information, social relationship network information, historical service information, current service state information, and physiological indicator information.

In some embodiments, the second sub-information includes information obtained by aggregating the terminal-related information with related information of a second device entity, or information obtained by performing information feature hiding on the information obtained by aggregating the terminal-related information with the related information of the second device entity.

In some embodiments, the radio frequency unit 901 is further configured to: in a case that the third processing method includes a method for processing by using a third neural network and the first information is the indication used to request the third sub-information, send the third sub-information to the first device entity, where the third sub-information is network parameter update information of the third neural network.

In some embodiments, the network parameter update information is obtained by training the third neural network based on terminal association information and terminal implementation.

An embodiment of this application further provides a network side device, including a processor and a communication interface. The communication interface is configured to send first information to a terminal, where
the first information is used to trigger the terminal to perform a first operation, and the first information includes at least one of the following:
a service feature extraction request, where the service feature extraction request is used to indicate the terminal to perform the first operation based on a first processing method;
first sub-information used to indicate the first processing method;
first assistance information used for the first processing method;
result information obtained by performing processing based on a second processing method;
an indication used to request second sub-information, where the second sub-information includes terminal-related information or information obtained by performing information feature hiding on the terminal-related information; and
an indication used to request third sub-information, where the third sub-information is used to update a third processing method.

In some embodiments, the communication interface is configured to send first target information to a first device entity, where the first target information includes related information of the second device entity or information obtained by performing second preset processing on the related information of the second device entity, and the first target information is used to determine first information sent by the first device entity to a terminal, where
the first information is used to trigger the terminal to perform a first operation, and the first information includes at least one of the following:
first sub-information used to indicate the first processing method;
first assistance information used for the first processing method; and
result information obtained by performing processing based on a second processing method. This network side device embodiment corresponds to the foregoing method embodiment on the network side device. Each implementation process and implementation of the foregoing method embodiment may be applicable to this network side device embodiment, and a same technical effect can be achieved.

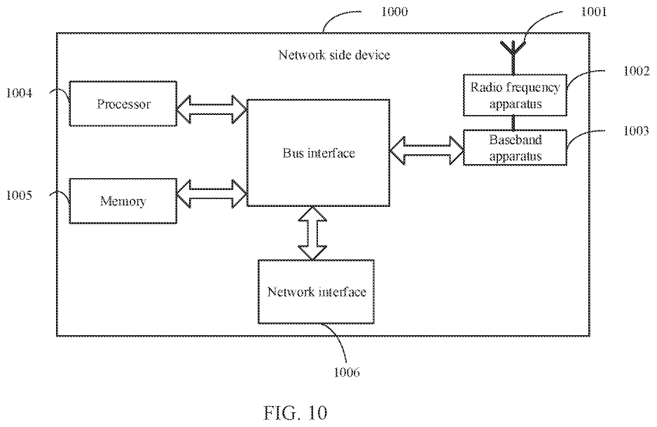

An embodiment of this application further provides a network side device. As shown in FIG. 10, a network side device 1000 includes an antenna 1001, a radio frequency apparatus 1002, and a baseband apparatus 1003. The antenna 1001 is connected to the radio frequency apparatus 1002. In an uplink direction, the radio frequency apparatus 1002 receives information by using the antenna 1001, and sends the received information to the baseband apparatus 1003 for processing. In a downlink direction, the baseband apparatus 1003 processes to-be-sent information, and sends the information to the radio frequency apparatus 1002. The radio frequency apparatus 1002 processes the received information and then sends the information by using the antenna 1001.

The frequency band processing apparatus may be located in the baseband apparatus 1003. The method performed by the network side device in the foregoing embodiment may be implemented in the baseband apparatus 1003. The baseband apparatus 1003 includes a processor 1004 and a memory 1005.

The baseband apparatus 1003 may include, for example, at least one baseband board, where a plurality of chips are disposed on the baseband board. As shown in FIG. 10, one chip is, for example, the processor 1004, which is connected to the memory 1005, so as to invoke a program in the memory 1005 to perform operations of the network side device shown in the foregoing method embodiment.

The baseband apparatus 1003 may further include a network interface 1006, configured to exchange information with the radio frequency apparatus 1002. For example, the interface is a Common Public Radio Interface (CPRI).

The network side device in this embodiment of this application further includes an instruction or a program that is stored in the memory 1005 and that can be run on the processor 1004. The processor 1004 invokes the instruction or the program in the memory 1005 to perform the method performed by the modules shown in FIG. 6 or FIG. 7, and a same technical effect is achieved. To avoid repetition, details are not described herein again.

An embodiment of this application further provides a readable storage medium. The readable storage medium may be non-volatile or volatile. The readable storage medium stores a program or an instruction, and the program or the instruction is executed by a processor to implement the processes of the foregoing information processing method embodiment, and a same technical effect can be achieved. To avoid repetition, details are not described herein again.

The processor is a processor in the electronic device in the foregoing embodiment. The readable storage medium includes a computer-readable storage medium, such as a computer Read-Only Memory (ROM), a Random Access Memory (RAM), a magnetic disk, or an optical disc.

An embodiment of this application further provides a chip. The chip includes a processor and a communication interface, the communication interface is coupled to the processor, and the processor is configured to run a program or an instruction to implement the processes of the foregoing information processing method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a program product. The program product is stored in a non-transient storage medium, and the program product is executed by at least one processor to implement the processes of the foregoing information processing method embodiment, and a same technical effect can be achieved. To avoid repetition, details are not described herein again.

It should be noted that, in this specification, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. in addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be a mobile phone, a computer, a server, an air conditioner, a base station, or the like) to perform the methods described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application,

1. A method for information processing, comprising:
receiving, by a terminal, first information sent by a first device entity; and
performing, by the terminal, a first operation according to the first information, the first operation is a service feature extraction-related operation,
wherein the first information comprises at least one of the following:
a service feature extraction request, wherein the service feature extraction request is used to indicate the terminal to perform the first operation based on a first processing method;
first sub-information used to indicate the first processing method;
first assistance information used for the first processing method;
result information obtained by performing processing based on a second processing method, an input of the second processing method comprises the terminal-related information;
an indication used to request second sub-information, wherein the second sub-information comprises terminal-related information or information obtained by performing information feature hiding on the terminal-related information, a manner of performing information feature hiding comprises at least one of the following: performing encryption processing and performing feature abstraction processing by using a preset neural network; or
an indication used to request third sub-information, wherein the third sub-information is used to update a third processing method.

2. The method according to claim 1, wherein the performing, by the terminal, the first operation according to the first information comprises any one of the following:
performing, by the terminal, the service feature extraction-related operation based on the first processing method, the service feature extraction-related operation comprises at least one of service prediction, service feature statistics, service feature key indicator extraction, and service experience statistics;
sending, by the terminal, the second sub-information or the third sub-information to the first device entity; or
performing, by the terminal, service feature extraction based on at least a part of information in the result information.

3. The method according to claim 1, wherein the first assistance information meets any one of the following:
the first assistance information is obtained by performing first preset processing on first target information;
the first assistance information is the first target information; or
the first assistance information is the first target information when the terminal performs authentication with the first device entity through a preset interaction authentication procedure,
wherein the first target information comprises related information of a second device entity or information obtained by performing second preset processing on the related information of the second device entity; and
the first preset processing or the second preset processing comprises at least one of the following: performing encryption processing or performing feature abstraction processing by using a preset neural network.

4. The method according to claim 3, wherein e related information of the second device entity comprises at least one of measurement information of the second device entity, implementation information of the second device entity, or statistics information of the second device entity, and the implementation information of the second device entity comprises at least one of antenna configuration information of the. second device entity, beam direction information of the second device entity, or location coordinate information of the second device entity; or
the measurement information of the second device entity comprises measurement information obtained by the second device entity on an air interface; or
the statistics information of the second device entity comprises statistics information obtained by performing long-term measurement on an air interface by the second device entity.

5. The method according to claim 3, wherein the related information of the second device entity comprises at least one of the following: information about the terminal on a corresponding carrier or bandwidth part; statistics information of one terminal on a plurality of carriers or bandwidth parts; or statistics information of a plurality of terminals.

6. The method according to claim 3, further comprising:
reporting, by the terminal, second assistance information to the first device entity, wherein the second assistance information comprises at least one of a public key of the encryption processing or recommendation information of a network parameter of the preset neural network.

7. The method according to claim 3, wherein the second device entity is configured to provide a network service for the terminal, and the second device entity is a base station, a core network device, or another network element other than the base station and the core network device.

8. The method according to claim 1, wherein the first processing method comprises a method for processing by using a first neural network, the first sub-information comprises neural network-related information of the first neural network, and the neural network-related information comprises at least one of a structure of the neural network or a parameter of the neural network.

9. The method according to claim 1, wherein the first device entity comprises one or at least two of the following: a base station, a local management function (LMF), a network data analytics function (NWDAF), a first network element, or a second network element, wherein the first network element is a network element configured to perform the second processing method, and the second network element is configured to perform at least one of the following: performing information collection on information required by the second processing method, or performing information calculation on the information required by the second processing method.

10. The method according to claim 1, further comprising:
communicating, by the terminal, with the first device entity to determine at least one of the following:
whether the terminal has a capability of performing a service prediction operation based on the first processing method;
available terminal-related information when the terminal performs the service prediction operation; or
a probability of performing different types of service transmission within a preset time period.

11. The method according to claim 1, wherein when the first information comprises the result information obtained by performing processing based on the second processing method, the method further comprises:
sending, by the terminal, second information to the first device entity, wherein the second information comprises at least one of the following:
information used to determine the second processing method; or
recommendation information of a network parameter of a second neural network when the second processing method is a method for processing by using the second neural network.

12. The method according to claim 1, wherein the terminal-related information comprises at least one of the following: location information, occupational or social state information, social relationship network information, historical service information, current service state information, or physiological indicator information.

13. The method according to claim 1, wherein the second sub-information comprises information obtained by aggregating the terminal-related information with related information of a second device entity, or information obtained by performing information feature hiding on the information obtained by aggregating the terminal-related information with the related information of the second device entity.

14. The method according to claim 1, wherein when the third processing method comprises a method for processing by using a third neural network and the first information is the indication used to request the third sub-information, after the receiving, by the terminal, the first information sent by the first device entity, the method further comprises:
sending, by the terminal, the third sub-information to the first device entity, wherein the third sub-information is network parameter update information of the third neural network, wherein the network parameter update information is obtained by training the third neural network based on terminal association information and terminal implementation.

15. A method for information processing, comprising:
sending, by a first device entity, first information to a terminal,
wherein the first information is used to trigger the terminal to perform a first operation, the first operation is a service feature extraction-related operation, and the first information comprises at least one of the following:
a service feature extraction request, wherein the service feature extraction request is used to indicate the terminal to perform the first operation based on a first processing method;
first sub-information used to indicate the first processing method;
first assistance information used for the first processing method;
result information obtained by performing processing based on a second processing method;
an indication used to request second sub-information, wherein the second sub-information comprises terminal-related information or information obtained by performing information feature hiding on the terminal-related information; or
an indication used to request third sub-information, wherein the third sub-information is used to update a third processing method.

16. The method according to claim 15, wherein the service feature extraction-related operation comprises at least one of service prediction, service feature statistics, service feature key indicator extraction, or service experience statistics.

17. The method according to claim 15, further comprising:
communicating, by the first device entity, with the terminal to determine at least one of the following:
whether the terminal has a capability of performing a service prediction operation based on the first processing method;
available terminal-related information when the terminal performs the service prediction operation; or
a probability of performing different types of service transmission within a preset time period.

18. The method according to claim 16, wherein the first preset processing or the second preset processing method comprises at least one of the following: performing encryption processing or performing feature abstraction processing by using a preset neural network; and the method further comprises:
receiving, by the first device entity, second assistance information sent by the terminal, wherein the second assistance information comprises at least one of a public key of the encryption processing or recommendation information of a network parameter of the preset neural network.

19. The method according to claim 18, wherein after the receiving, by the first device entity, second assistance information sent by the terminal, the method further comprises:
sending, by the first device entity, the second assistance information to a second device entity.

20. A method for information processing, comprising:
sending, by a second device entity, first target information to a first device entity, wherein the first target information comprises related information of the second device entity or information obtained by performing second preset processing on the related information of the second device entity, and the first target information is used to determine first information sent by the first device entity to a terminal,
wherein the first information is used to trigger the terminal to perform a first operation, the first operation is a service feature extraction-related operation, and the first information comprises at least one of the following:
first sub-information used to indicate the first processing method;
first assistance information used for the first processing method; or
result information obtained by performing processing based on a second processing method.
